(19) United States
(12) Patent Application Publication
(10) Pub. No.: US 2014/0229075 A1
(43) Pub. Date: Aug. 14, 2014

(54) AFTERMARKET HVAC CONTROL DEVICE FOR CONTROLLING A VEHICLE CLIMATE CONTROL SYSTEM

(71) Applicant: SCOSCHE INDUSTRIES, INC., Oxnard, CA (US)

(72) Inventor: Ted LOPEZ, Oxnard, CA (US)

(73) Assignee: SCOSCHE INDUSTRIES, INC., Oxnard, CA (US)

(21) Appl. No.: 14/255,665

(22) Filed: Apr. 17, 2014

Related U.S. Application Data
(63) Continuation of application No. PCT/US2012/060433, filed on Oct. 16, 2012.
(60) Provisional application No. 61/547,931, filed on Oct. 17, 2011.

(51) Int. Cl. B60H 1/00

(52) U.S. Cl. CPC B60H 1/00985
USPC 701/45; 29/402.08; 701/36; 701/48

(57) ABSTRACT

Disclosed is an HVAC control device for controlling a vehicle climate control system having a plurality of control elements. The HVAC control device includes a housing having a common size dimensioned for installing in a complementary receptacle in the vehicle climate control panel, the size common to replacement vehicle climate control panels for vehicles made by one than on vehicle manufacturer. On the front surface of the housing is a user interface by which a user can operate the vehicle climate control system. In the housing is a controller adapted to control more than one different vehicle climate control system.

### CROSS-REFERENCE TO RELATED APPLICATION

This application claims priority to U.S. Provisional Application No. 61/547,931 entitled “AFTERMARKET HVAC CONTROL DEVICE FOR CONTROLLING A VEHICLE CLIMATE CONTROL SYSTEM” filed Oct. 17, 2011, and assigned to the assignee hereof and hereby expressly incorporated by reference herein.

### BACKGROUND

1. Field

The disclosure relates to a device for controlling a vehicle climate control system. In particular, the disclosure relates to an aftermarket heating ventilation air conditioning (“HVAC”) control device for controlling a vehicle climate control system.

2. Background

Most cars today come with an AM/FM radio tuner and/or compact disk (CD) player installed in the vehicle's climate control panel. However, numerous other types of after-market car audio and video equipment are also available today, such as digital media players (e.g., mp3 players, DVD players, minidisk players), CD changers, satellite radio tuners, video screens for navigation systems and drive assist systems, and the like. As more and different components become available, people want the flexibility to customize and/or upgrade their existing audio and video equipment to take advantage of the new innovations in car audio and video equipment.

To a great extent, this desired flexibility is limited by the fact that many new vehicles have the original factory-installed components audio and video components integrated with the climate control device(s) in the vehicle's climate control panel. This makes it impossible for a user to remove the factory AM/FM radio tuner and other original factory-installed components without losing the functionality of the integrated climate control system. Another factor that makes it difficult to upgrade or customize is that factory-installed vehicle climate control systems are not of a common shape or size, meaning that a single aftermarket HVAC control device cannot be used in all aftermarket upgrades and customizations.

For these and other reasons, there remains a need in the art for an aftermarket heating ventilation air conditioning (“HVAC”) control device that can be easily incorporated into the vehicle climate control panel panels for a wide variety of different vehicle models and trim levels. There is a further need for a simple and effective control device that controls not controls a vehicle's climate controls, but can control and display information from other systems and devices, such as audio devices and systems, video devices and systems, anti-theft devices and systems, navigation devices and systems, electronic diagnosis systems, drive assist systems, steering wheel audio control systems, radar detector devices, and integrated cellular phone devices or systems.

### SUMMARY

Disclosed is an HVAC control device for controlling a vehicle climate control system having a plurality of control elements. The HVAC control device is adapted for installing in a vehicle climate control panel.

The HVAC control device includes a housing having a front surface, wherein the housing has a common size dimensioned for installing in a complementary receptacle in the vehicle climate control panel, the size common to replacement vehicle climate control panels for vehicles made by one than on vehicle manufacturer.

On the front surface of the housing is a user interface by which a user can operate the vehicle climate control system. Disposed in the housing and adapted to control the climate control system in accordance with user input to said user interface is a controller, wherein the controller, in response to the user input, creates command inputs commanding action within the climate control system and transmits the command inputs to the climate control system, wherein the controller, in response to the status outputs indicating the status of the climate control system, regulates the operation of at least a one of the control elements, and wherein the controller is configured to control more than one different vehicle climate control system.

In some aspects, the user interface includes a plurality of push buttons, wherein each push button is adapted to operate a control element. In some aspects, the push buttons include an indicator light adapted to indicate the status of the control element operated by the push button. And in some aspects, the user interface includes an interactive video display, such as a touch screen, including an LCD touch screen, adapted to operate at least one of the control elements. In some aspects, the controller comprises a microcontroller. And in some aspects, the microcontroller is programmable and the user interface is adapted to allow the user to write custom software for controlling a control element.

In some embodiments, the printed circuit board includes at least one primary input/output connector configured to operably connected the microcontroller to a vehicle bus system and in some embodiments, the printed circuit board includes at least one supplemental connector configured to operably connected the microcontroller to an external electrical device or system. In some aspects, the microcontroller is configured to additionally control and display information from at least one other vehicle device or system. Representative other vehicle devices and systems include, without limitation, an audio device or system, a video device or system, anti-theft device or system, a navigation device or system, an electronic diagnosis system, a drive assist system, a steering wheel audio control system, a radar detector device, and an integrated cellular phone devices or system.

In some aspects, the microcontroller is mounted on a printed circuit board. And is some aspects, the printed circuit board is adapted to interface with a vehicle bus system. In some aspects, the HVAC control device further comprising a speaker operably connected to the connector.

Also disclosed is a method for installing the HVAC control device into the vehicle. The method comprises removing a first vehicle climate control panel from the vehicle, wherein the first vehicle climate control panel comprises a first receptacle, the first receptacle having a first non common size and shape, installing a second vehicle climate control panel in the vehicle, wherein the second vehicle climate control panel comprises a second receptacle, the second receptacle having a first common size and shape, and installing a second HVAC control device for a vehicle climate control system having a plurality of control elements in the second receptacle, the second HVAC control device having a size and shape complementary to the first common size and shape.

In some aspects, the HVAC control device comprises a housing having a front surface, wherein the housing has the first common size and shape. On the front surface of the housing is a user interface by which a user can operate a vehicle climate control system having a plurality of control elements. In the housing is a controller adapted to control the climate control system in accordance with user input to the user interface, wherein the controller, in response to the user input, creates the command inputs commanding action within the climate control system and transmits the command inputs to the climate control system, wherein the controller, in response to the status outputs indicates the status of said climate control system and regulates the operation of at least one of the control elements of the climate control system. In some aspects, the controller is configured to control more than one different vehicle climate control system.

In some aspects, the user interface includes a plurality of push buttons, wherein each push button is adapted to operate a control element. In some aspects, the push buttons include an indicator light adapted to indicate the status of the control element operated by the push button. And in some aspects, the user interface includes an interactive video display, such as a touch screen, including an LCD touch screen, adapted to operate at least one of the control elements. In some aspects, the controller comprises a microcontroller. And in some aspects, the microcontroller is programmable and the user interface is adapted to allow the user to write custom software for controlling a control element.

In some aspects, the controller comprises a microcontroller. Some aspects further comprise programming the microcontroller to control at least one control element of a vehicle climate control system. In some embodiments, the printed circuit board includes at least one primary input/output connector configured to operably connected the microcontroller to a vehicle bus system and in some embodiments, the printed circuit board includes at least one supplemental connector configured to operably connected the microcontroller to an external electrical device or system.

In some embodiments, the method further comprises programming the microcontroller to control at least one control element of a vehicle climate control system. And ins some embodiments, the method comprises interfacing the HVAC control device with a vehicle bus system, while in some embodiment, the method comprises interfacing the HVAC control device with an external electronic device or system.

In some aspects, the second vehicle climate control panel comprises a third receptacle, the third receptacle having a second common size and shape and the method further comprises installing an AM/FM turner in the third receptacle, the AM/FM turner having a size and shape complementary to the second common size and shape.

And in some aspects, the second vehicle climate control panel comprises a fourth receptacle, the fourth receptacle having a third common size and shape and the method further comprises installing a navigation system in the fourth receptacle, the navigation system having a size and shape complementary to the third common size and shape.

### BRIEF DESCRIPTION OF THE DRAWINGS

The accompanying drawings, together with the specification, illustrate exemplary embodiments, and, together with the description, serve to explain the principles of these embodiments.

FIG. 1 is an exploded, perspective view of a vehicle climate control panel, along with aftermarket components, including an HVAC control device in accordance with one aspect of the disclosure.

FIG. 2 is a front plan view of the HVAC control device shown in FIG. 1.

FIG. 3 is a rear plan view of the HVAC control device shown in FIG. 1.

FIG. 4 is an exploded, perspective view of the HVAC control device shown in FIG. 1.

FIG. 5 is a perspective view of the HVAC control device shown in FIG. 1.

FIG. 6 is a system block diagram of a portion of the controller in accordance with one aspect of the invention.

### DETAILED DESCRIPTION

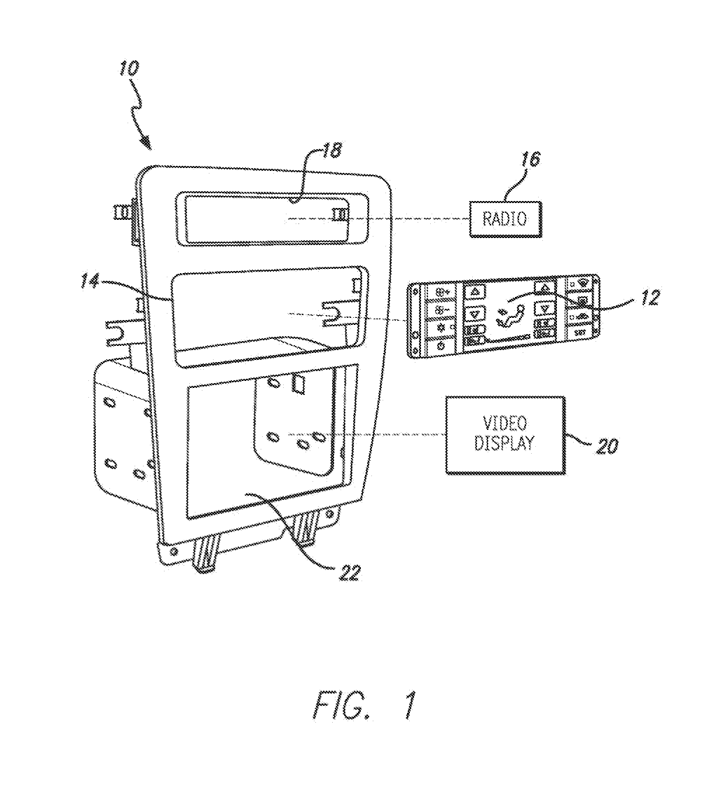

Shown in FIG. 1 is an exploded, perspective view of an exemplary aftermarket replacement vehicle control panel 10, along with aftermarket components. The aftermarket components include an HVAC control device 12 for controlling a vehicle climate control system having a plurality of control elements. In some embodiments, the HVAC control device controls and displays information from at least one other vehicle device or system, such as at least one of an audio device or system, a video device or system, an anti-theft device or system, a navigation device or system, an electronic diagnosis system, a drive assist system, a steering wheel audio control system, a, radar detector device, an integrated cellular phone devices and the like.

The HVAC control device 12 has a first a common size that is dimensioned for installing in a complementary receptacle 14 in the vehicle climate control panel 10, the size common to replacement vehicle climate control panels for vehicles made by one than on vehicle manufacturer. An AM/FM radio tuner 16 of a second common size that is dimensioned for installing in a complementary receptacle in the vehicle climate control panel, the second size common to replacement vehicle climate control panels for vehicles made by one than on vehicle manufacturer, can be configured for installation in second complementary receptacle 18 in the replacement vehicle climate control panel. And a video display screen 20, such as a video display screen for a navigation system or a vehicle backup viewing system, of a third a common size that is dimensioned for installing in a complementary receptacle in the vehicle climate control panel, the third size common to replacement vehicle climate control panels for vehicles made by one than on vehicle manufacturer, can be configured for installation in a third complementary receptacle 22 in the replacement vehicle climate control panel.

The exemplary aftermarket replacement vehicle climate control panel 10 has the size and shape required to replace a vehicle's original climate control panel. Therefore, it is to be understood that the size of the vehicle climate control panel shown in FIG. 1 is for illustrative purposes only. The replacement vehicle climate control panel can have any of the variety of shapes and sizes necessary to replace the variety of climate control panel originally found in a variety of different vehicle models and trim levels. Furthermore, the number of components and the number of openings in the vehicle climate control panel can also vary depending on the particular upgrade or customization package desired by a consumer of aftermarket components. However, because the disclosed HVAC control device 12 has a first common shape (shown as substantially rectangular in exemplary FIG. 1) and size corresponding to a first complementary receptacle 14 in all of the replacement vehicle climate control panels, a single aftermarket HVAC control device can be used with every replacement vehicle climate control panel.

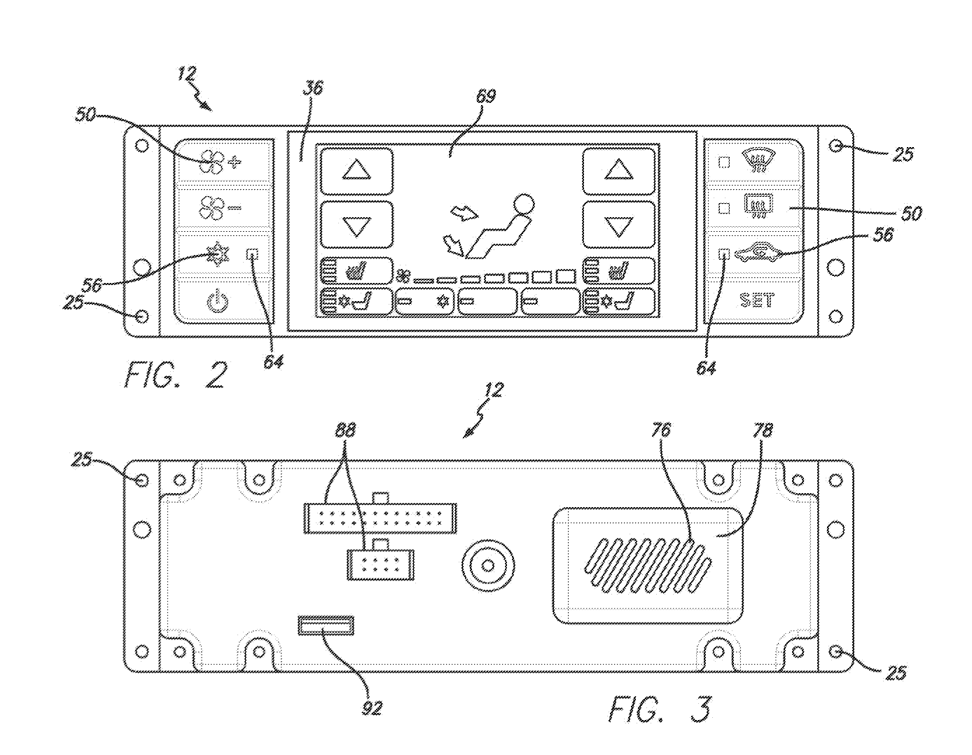

The HVAC control device 12 is attached to the replacement vehicle climate control panel 10 by any suitable method. As best seen, for example, in FIG. 2, a front plan view of the HVAC control device, and FIG. 3, a rear plan view of the HVAC control device, in some aspects, the HVAC control device is attached to the vehicle climate control panel using a plurality of mounting holes 25 with fasteners (not shown).

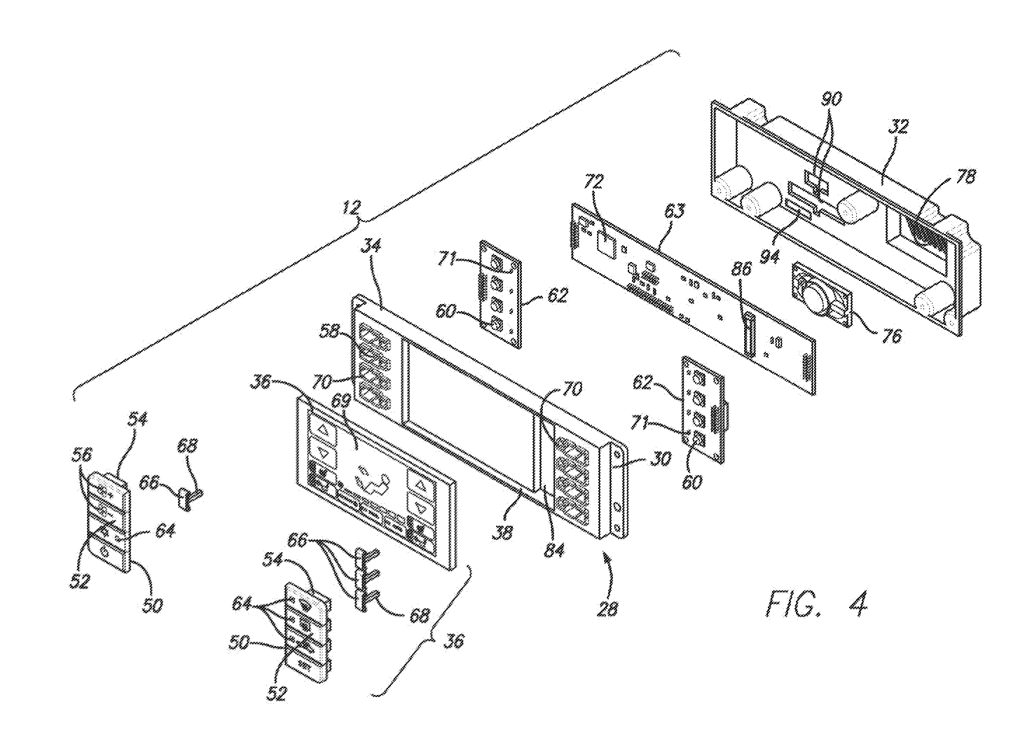

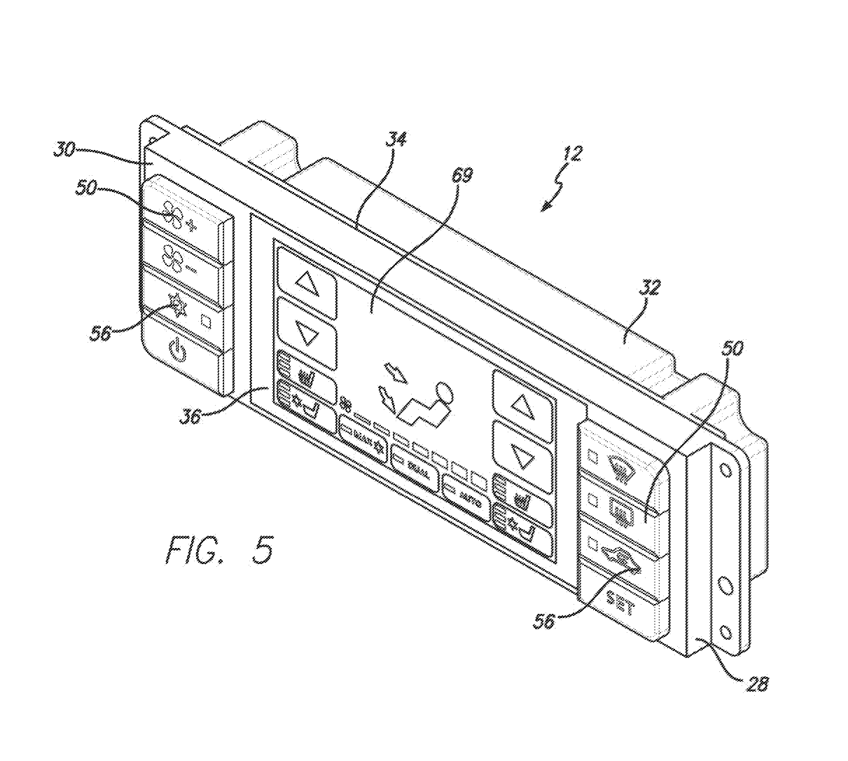

Turning to FIGS. 4 and 5, shown in FIG. 4 is an exploded, perspective view of the HVAC control device 14; shown in FIG. 5 is a perspective view of the HVAC control device. The device comprises a housing 28 having a front surface 30. In some aspects, the housing includes a back cover 32 and a front panel 34, the front panel bearing the front surface.

A user interface 36 by which a user can operate the vehicle climate control system having a plurality of control elements is disposed on the front surface 30 of the housing 28. In one aspect, the user interface includes a plurality of push buttons 50 (eight shown in the representative FIGS. 2, 4 and 5), each push button adapted to operate a control element. As best seen in FIG. 4, face contains an indicia 56 indicating the control element operated when the push button is depressed. In some aspects the buttons are replaceable, so that the indicia can be changed depending on the vehicle model and trim level. Each actuator stem extends through a push button opening 58 in the front panel 34 and is operably connected to a push button switch 60 on a circuit board 62 (two shown) operably connected to a printed circuit board (PCB) 63 for communication with the climate control system of the vehicle.

In some aspects, one or more of the pushbuttons 50 contain an indicator window 64 (four shown in the representative FIGS. 2, 4 and 5). Aligned beneath each window is a visible indicator 66 that visibly indicates the status of the control element operated by the push button. Preferably, the visible indicators comprise light emitting diodes LEDs. The LEDs may be all of the same color or of different colors, and may or may not be dimmable with the instrument panel of the vehicle.

As best seen in FIG. 4, in some aspects, each LED has an actuator portion 68 extending through a visible indicator opening 70 in the front panel 34. The actuator portion is operably connected to a visible indicator switch 71 to the circuit board 62, so that when the corresponding push bar is first depressed the light turns on and when the corresponding push bar is depressed again, the light turns off to indicate the status of the control element operated by the push button.

In some aspects, the HVAC control device additionally includes a display 69 for displaying test or picture information. In some aspects, the display is substantially rectangular and is disposed in a recess having the same dimensions.

In some embodiments, the display 69 is an interactive display, which comprises part of the user interface device. Representative interactive displays include touch screens, including but not limited to an LCD touch screens, configured to operate at least one of the control elements disposed in a recess 38 in the front panel 34. Data can be input through contacting the touch screen.

A controller configured to control more than one different vehicle climate control system is disposed in the housing. The controller is configured to control a vehicle climate control system in accordance with user input from the user interface. In some aspects, the controller is configured to control and display information from at least one other vehicle device or system. Representative devices and systems include, without limitation, audio devices and systems, video devices and systems, anti-theft devices and systems, navigation devices and systems, electronic diagnosis systems, drive assist systems, steering wheel audio control systems, radar detector devices, integrated cellular phone devices and systems and the like.

In some aspects the controller is a microcontroller 72 which can run at least one operating system or at least on software program; and can run at least an open-end multi operating system such as Windows CE, Windows 7 Embedded or embedded Linux or a plurality of software programs. The microcontroller can be controlled or data can be input into the microcontroller through touching an image or text information displayed on the touch screen. In some aspects, the controller is mounted to the PCB 63.

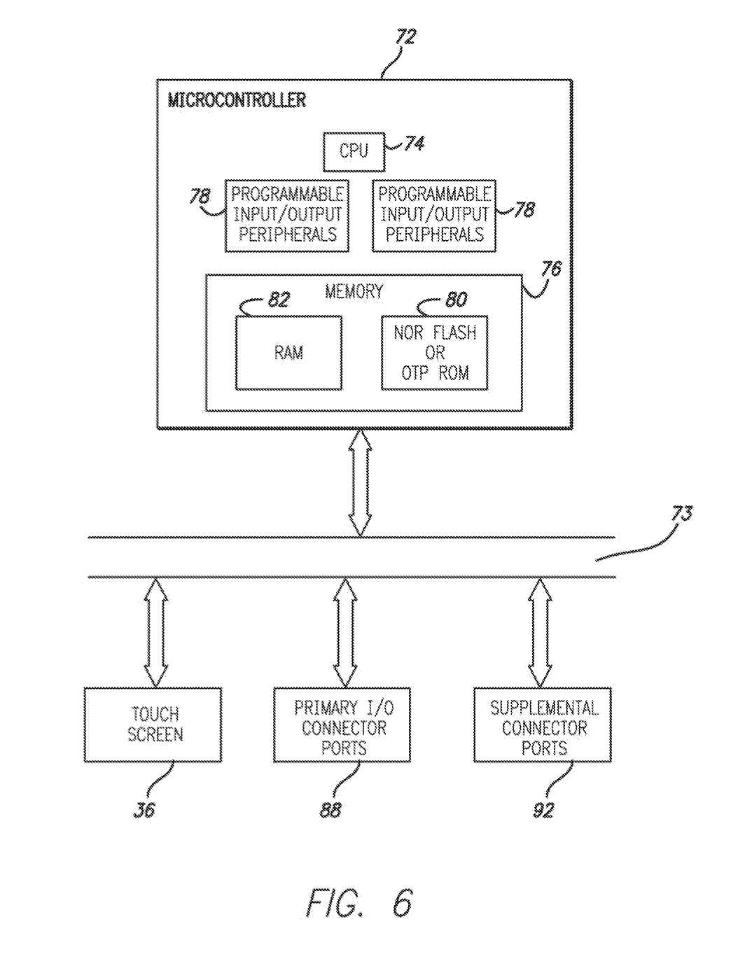

Referring to FIG. 6, in some aspects the microcontroller 72 includes, a CPU 74, memory 76, and, in some embodiments, programmable input/output peripherals. The CPU is used to run the operating system, a plurality of application programs or a plurality of drives or for processing, operation or access of data.

In some aspects, the program memory is in the form of NOR flash or OTP ROM 82 and in some aspects, the microcontroller includes RAM. The NOR flash or OTP ROM is used to store software such as the operating system, the application programs and the drivers. The RAM memory is used to store temporarily the operating system, the application programs or the drivers run by the CPU or data operated by the CPU.

The touch screen 36 is operably connected to the microcontroller 72, for example by a plurality of pins (not shown) which extend through a touch screen opening 84 in the front panel 34 and mate with slots 86 in the PCB 63 which are connected to microcontroller via bus 73. In some aspects, the controller is programmable and the touch screen is adapted to allow the user to write custom software for controlling a vehicle climate control system.

Referring additionally to FIGS. 3 and 4, in some aspects, the PCB 63 includes at least one primary input/output connector 88 (two shown in FIG. 3) operably connected to the microcontroller 72 via bus 73. The primary input/output connector ports extend through complementary input/output connector port openings 90 in the back cover 32 (as seen in FIG. 4), so that they can be interfaced with the vehicle's bus communication system using a suitable wiring harness. In some aspects, the primary input/output connector ports also provide a means for installing firmware updates and for attaching add-on-modules.

In some aspects, the PCB 63 also includes at least one supplemental connector port 92 for connection of external electronic devices (FIG. 3). Representative connectors include, without limitation serial connector ports, parallel connector ports, data communication connector ports, such as USB ports or IEEE1394 ports, display connection ports and audio connection ports. The secondary connector ports extend through complementary secondary connector port openings 94 in the back cover 32 (FIG. 3), so that they can be interfaced with external electronic devices and systems. Representative external electronic devices include, without limitation audio devices and systems, video devices and systems, anti-theft devices and systems, navigation devices and systems, electronic diagnosis systems, drive assist systems, steering wheel audio control systems, radar detector devices, integrated cellular phone devices and systems and the like.

As also seen in FIGS. 3 and 4, in some aspects, a speaker 76 is mounted on the circuit board 63 and operably connected to the controller 72. The speaker is oriented so that sound is directed through grating 78 in the back cover 32. The speaker allows for warning chimes and other vehicle audio signals to be retained, after the factory installed radio has been removed.

The user interface is configured to operate a vehicle climate control system having a plurality of control elements. The user interface can include, without limitation, a fan speed selection interface, a temperature selection interface, a mode selection interface, including a single/dual control selector, an air conditioning selector, including a maximum air conditioning selector, front and rear window defogger selectors, a recirculation/fresh selector, and a rear window defrost selector, driver and passenger seat heater selectors and driver and passenger seat air conditioner selectors. In some aspects, for example, as best seen in exemplary FIG. 2, the touch screen includes the temperature selection interface, the heated and air conditioned seat selector, the maximum air conditioning selector, the single/dual control selector and the mode selector, while the push buttons include the fan speed selector, the air conditioning selector, the front and rear window defogger selectors, and a recirculation/fresh selector, as well as on-off and set buttons. And in some aspects, the touch screen is adapted to display climate controls that are not used in every model or trim level, as well as to display vehicle personalization options and the like.

In response to user input, the controller creates command inputs commanding action for the plurality of control elements within the vehicle climate control system and transmits the command inputs to the vehicle climate control system. In addition, in response to status outputs indicating the status of the vehicle climate control system, the controller regulates the operation of at least a portion of the climate control system. The controller is configured to control climate control systems of more than one vehicle and/or trim package, in order that the same HVAC control device can be used to control more than one vehicle and/or trim package.

In some aspects, the controller provides individual or dual control of a blower fan motor, a mode selection motor, an air temperature mix motor, a recirculate/fresh motor, an air conditioner compressor, a rear window defroster, driver and passenger seat heaters and driver and passenger seat air conditioners of the vehicle, as well as the user interface.

In some aspects, the blower fan speed can be either increased or decreased using the appropriate fan speed selection push button. The mode selection interface is used to select where in the vehicle to direct air from the climate control system, and, in some aspects, is operated by the touch screen, each zone, ranging from the front defrost vents to the “face” vents to the floor vents shown on the touch screen display. Each zone is associated with one or more vents of the vehicle. The mode selection motor opens and closes ducts to direct air to the various vents of the climate control system in response to input to the mode selection interface by the user. In some aspects, in order to change modes, the controller drives a reversible mode selection motor in the appropriate direction until the desired mode is achieved. By making the appropriate selection, the user can cause air to be directed to the vent(s) associated with the zone or zones.

The air temperature mix interface, in some aspects, displayed on the touch screen, allows a user to adjust the temperature of the air coming out of the vehicle vents. User input from the air temperature mix interface is fed to the controller. The controller directs an air temperature mix motor to adjust the temperature of the air coming out of the vents.

In some aspects, a recirculate/fresh selector button allows a user to select whether recirculated air or fresh (i.e., outside) air is used as the air source of the climate control system. User input from the recirculate/fresh selector is fed directly to the controller. The controller drives a recirculate/fresh motor to open or close a fresh air duct in response to operation of the recirculate/fresh selector by the user.

In some aspects, the air conditioning selector button allows the user to activate or deactivate the air conditioning compressor of the vehicle. User input from the air conditioning selector is fed directly to the controller. The controller activates or deactivates the air conditioning compressor of the vehicle in response to operation of the air conditioning selector by the user. And in some aspects, the maximum are conditioning selector button causes the controller to activate the air conditioning compressor to operate at its maximum level.

In some aspects, the rear window defrost selector button allows the user to activate or deactivate a rear window defroster of the vehicle. User input from the rear window defrost selector is fed to the controller. The controller activates or deactivates the rear window defroster of the vehicle in response to operation of the rear window defrost selector button by the user.

The driver and passenger seat heater interfaces and the driver and passenger seat air conditioner interfaces, in some aspects, are operated by the touch screen. User input from the driver and passenger seat heater interfaces and the driver and passenger seat air conditioner interfaces is fed to the controller. The controller activates or deactivates the driver and passenger seat heaters and the driver and passenger seat air conditioners of the vehicle in response to operation of the driver and passenger seat heater interfaces and the driver and passenger seat air conditioner interfaces by the user.

In some aspects, the HVAC control device 12 is additionally configured to control and display information from at least one other device or system. In some embodiments, the device or system is internal, i.e., is connected to the microcontroller 72 via the vehicle bus system using a primary input/output connector 88. In alternate embodiments, the system or device is external, i.e., is directly connected to the microcontroller via a supplemental connector 90. In some embodiments, the display 69 is a touch screen and is used to control the device or system.

Representative systems and devices include, without limitation, audio devices, such as satellite radio and high definition radio devices and systems, and that provide sound files full meta data and album art and the like; video devices and systems, such as a DVD players, that provide video images; anti-theft devices and systems; GPS navigation devices and systems, including black box add-on devices, that provide compass headings and other navigational information; electronic diagnosis systems, including OBD I and OBD II systems, that provide vehicle speed, engine RPMs, engine oil pressure, engine coolant temperature, battery voltage, vehicle maintenance reminders, mileage, turbo timers, G's and like data; drive assist systems, including, vehicle backup sensor devices, vehicle front and or rear cameras; steering wheel audio control devices; radar detectors; home automation devices, such as automatic garage doors, automatic security gates and other home lighting and security devices and systems, and integrated and handheld cellular phone devices and systems and the like, that provide phonebooks and similar information.

In some aspects, the aftermarket HVAC control device 12 is installed by first removing a vehicle climate control panel having a first receptacle with a non common shape and size from a vehicle for an HVAC control device having a complementary shape and size to the first receptacle from the vehicle climate control panel. The vehicle climate control panel is replaced by installing a vehicle climate control panel having a receptacle with a common size and shape and the HVAC control device is replaced by installing an aftermarket HVAC control device having a shape complementary to the first common shape and size of the receptacle into the receptacle.

In some further aspects, an AM/FM radio tuner of a second common shape and size is installed in a second complementary receptacle in the replacement vehicle climate control panel. And in some further aspects, a display of a third common shape and size is installed in a third complementary receptacle in the replacement vehicle climate control panel.

As disclosed herein, an HVAC control devices that can be easily incorporated into the vehicle climate control panel panels for a wide variety of different vehicle models and trim levels has been described.

In the foregoing specification, various aspects of the invention have been described with reference to specific exemplary embodiments. Various modifications and changes may be made, however, without departing from the scope of the present invention. The specification and figures are illustrative, rather than restrictive, and modifications are intended to be included within the scope of the present invention. Accordingly, the scope of the invention should be determined by the claims and their legal equivalents rather than by merely the examples described. With regard to particular embodiments described above, any benefit, advantage, solution to a problem, or any element that may cause any particular benefit, advantage, or solution to occur or to become more pronounced are not to be construed as critical, required, or essential features or components of any or all the claims.

As used herein, the terms “comprise,” “comprises,” “comprising,” “having,” “including,” “includes” or any variation thereof, are intended to reference a non-exclusive inclusion, such that a process, method, article, composition or apparatus that comprises a list of elements does not include only those elements recited, but may also include other elements not expressly listed or inherent to such process, method, article, composition, or apparatus. Other combinations and/or modifications of the above-described structures, arrangements, applications, proportions, elements, materials, or components used in the practice of the present invention, in addition to those not specifically recited, may be varied or otherwise particularly adapted to specific environments, manufacturing specifications, design parameters, or other operating requirements without departing from the general principles of the same.

What is claimed is:

1. An HVAC control device for controlling a vehicle climate control system having a plurality of control elements, the HVAC control device configured for installing in a vehicle climate control panel, the HVAC control device comprising:
a housing having a front surface, said housing having a common size, dimensioned for installing in a complementary receptacle in the vehicle climate control panel, the size common to replacement vehicle climate control panels for vehicles made by one than on vehicle manufacturer;
a user interface on the front surface of the housing, by which a user can operate a vehicle climate control system having a plurality of control elements and
a controller disposed in the housing and configured to control said climate control system in accordance with user input to said user interface, wherein said controller, in response to said user input, creates said command inputs commanding action within said climate control system and transmits said command inputs to said climate control system, wherein said controller, in response to said status outputs indicating said status of said climate control system, regulates the operation of at least a portion of said climate control system, and wherein the controller is configured to control at least one of the control elements of the vehicle climate control system.

2. The HVAC control device of claim 1, wherein the user interface comprises a plurality of push buttons, each push button adapted to operate a control element.

3. The HVAC control device of claim 2, wherein at least on the push buttons further comprises an indicator light adapted to indicate the status of the control element operated by the push button.

4. The HVAC control device of claim 1, wherein the user interface comprises a display for displaying text or picture information.

5. The HVAC control device of claim 4, wherein the display comprises an interactive display adapted to operate at least one of the control elements.

6. The HVAC control device of claim 5, wherein the interactive display comprises a touch screen.

7. The HVAC control device of claim 6, wherein the touch screen comprises an LCD touch screen.

8. The HVAC control device of claim 2, wherein the user interface comprises an interactive display adapted to operate at least one of the control elements.

9. The HVAC control device of claim 8, wherein the interactive display comprises a touch screen.

10. The HVAC control device of claim 1, wherein the controller comprises a microcontroller.

11. The HVAC control device of claim 10, wherein the microcontroller is programmable and the user interface is adapted to allow the user to write custom software for controlling a vehicle climate control system.

12. The HVAC control device of claim 10, wherein the microcontroller is mounted on a printed circuit board.

13. The HVAC control device of claim 12, wherein the printed circuit board includes at least one primary input/output connector configured to operably connect the microcontroller to a vehicle bus system.

14. The HVAC control device of claim 13, wherein the printed circuit board includes at least one supplemental connector configured to operably connect the microcontroller to an external electrical device or system.

15. The HVAC control device of claim 1, further comprising a speaker operably connected to the connector.

16. The HVAC control device of claim 1, wherein the HVAC control device additionally controls or displays information from at least one other vehicle device or system.

17. The HVAC control device of claim 16, wherein the at least one other vehicle device or system is an audio device or system, a video device or system, anti-theft device or system, a navigation device or system, an electronic diagnosis system, a drive assist system, a steering wheel audio control system, a radar detector device, and an integrated cellular phone devices or system.

18. A method for installing an HVAC control device into a vehicle comprising:
removing a first vehicle climate control panel from a vehicle, the first vehicle climate control panel comprising a first receptacle, the first receptacle having a first non common size and shape;
removing a first HVAC control device for a vehicle climate control system having a plurality of control elements from the first receptacle, the first HVAC control device having a shape complementary to the first non common size and shape;
installing a second vehicle climate control panel in the vehicle, the second vehicle climate control panel comprising a second receptacle, the second receptacle having a first common size and shape; and
installing a second HVAC control device for a vehicle climate control system having a plurality of control elements in the second receptacle, the second HVAC control device having a size and shape complementary to the first common size and shape.

19. The method of claim 18 wherein the HVAC control device comprises:
a housing having a front surface, said housing having the first common size and shape;
a user interface on the front surface of the housing, by which a user can operate a vehicle climate control system having a plurality of control elements and
a controller disposed in the housing and adapted to control said climate control system in accordance with user input to said user interface, wherein said controller, in response to said user input, creates said command inputs commanding action within said climate control system and transmits said command inputs to said climate control system, wherein said controller, in response to said status outputs indicating said status of said climate control system, regulates the operation of at least a portion of said climate control system.

20. The method of claim 19 wherein the controller is configured to control more than one different vehicle climate control system.

21. The method of claim 20 wherein the user interface comprises an interactive display adapted to operate at least one of the control elements.

22. The method of claim 21, wherein the interactive display comprises a touch screen.

23. The method of claim 21, wherein the interactive display further comprises a plurality of push buttons, each push button adapted to operate a control element.

24. The method of claim 19, wherein the controller comprises a microcontroller.

25. The method of claim 18, further comprising programming the microcontroller to control at least one control element of a vehicle climate control system.

26. The method of claim 18, further comprising interfacing the HVAC control device with a vehicle bus system.

27. The method of claim 18, further comprising interfacing the HVAC control device with an external electronic device or system.

28. The method of claim 18, wherein the second vehicle climate control panel comprises a third receptacle, the third receptacle having a second common size and shape and further comprising installing an AM/FM turner in the third receptacle, the AM/FM turner having a size and shape complementary to the second common size and shape.

29. The method of claim 18, wherein the second vehicle climate control panel comprises a fourth receptacle, the fourth receptacle having a third common size and shape and further comprising installing a navigation system in the fourth receptacle, the navigation system having a size and shape complementary to the third common size and shape.
